(19) United States
(12) Patent Application Publication
(10) Pub. No.: US 2024/0311669 A1
(43) Pub. Date: Sep. 19, 2024

(54) QUANTUM CIRCUIT COMPRESSION

(71) Applicant: HSBC Group Management Services Limited, London (GB)

(72) Inventors: Christos ARAVANIS, Sheffield (GB); Georgios KORPAS, London (GB); Jakub MARECEK, Prague (CZ); Philip INTALLURA, London (GB)

(73) Assignee: HSBC Group Management Services Limited, London (GB)

(21) Appl. No.: 18/491,251

(22) Filed: Oct. 20, 2023

(30) Foreign Application Priority Data
Mar. 17, 2023 (GB) 2303962.1

(51) Int. Cl. G06N 10/20

(52) U.S. Cl. CPC G06N 10/20

(57) ABSTRACT

A method of compressing a quantum circuit using a quantum circuit compressor is disclosed. The method comprises receiving data defining a quantum circuit and identifying a section of the quantum circuit that matches a predetermined circuit template. The circuit template specifies a first arrangement of quantum gates including at least one SWAP gate for implementing a non-local interaction and is associated with a predetermined second arrangement of quantum gates that does not include the SWAP gate. The compressor determines whether the circuit section meets a compression criterion. In response to determining that the circuit section meets the compression criterion; the compressor modifies the circuit definition to replace the first arrangement of quantum gates with the second arrangement of quantum gates, and outputs the modified circuit definition, for example to a quantum computing system for execution of the modified circuit.

### FIELD OF THE INVENTION

The present application relates to methods and systems for compressing quantum circuits.

### BACKGROUND OF THE INVENTION

Quantum technologies and quantum computing in particular are advancing in an unprecedented pace. As a result, the capabilities of quantum computers are constantly increasing wherein the first signs of “quantum supremacy” or “quantum advantage” hint that it might not take as long as originally thought to adopt them in a large scale. However, the current generation of quantum computers, often termed the Noisy Intermediate-Scale Quantum (NISQ) computers, suffer from various limitations which make them quite hard to exploit for useful applications across various domains such as finance, logistics, chemistry or material science. A key limitation is known as the (effective) depth of a quantum circuit. In the quantum circuit model, one applies a sequence of unitary transformations U on quantum states. The number of subsequent non-parallel applications of unitary transformations on (up to) two qubits at a time, is known as the depth of the circuit. The depth of the circuit is limited by the ratio of coherence time and gate time, as well as the fidelity of the two-qubit gates. The limit on the depth of a quantum circuit limits what algorithms can be implemented, and the quality of the output, despite the flourishing of various error mitigation techniques. While Fault Tolerant Error Corrected (FTEC) quantum computers will be more resilient to these limitations, one may envision that even there, it will be preferable to reduce the number of gates. Circuit transpiling techniques, which can reduce circuit depth, will be essential in both the NISQ and FTEC eras of quantum computing. The transpiling of quantum circuits starting from a potentially large gate set to a particular hardware-specific “native” gate set, can be quite challenging, especially in architectures with limited connectivity. Limited connectivity is another key limitation of the current quantum computers and several challenges must be overcome to fully exploit these powerful machines. Notice that, due to the limited connectivity, two-qubit gates often cannot be readily applied and the states of the corresponding qubits must be swapped with those of their neighbors until the states reside on qubits where a two qubit gate is supported. SWAP gates are, however, often expensive. For instance in CNOT-based native gate sets, they are often implemented using three CNOT gates. As a result, reducing the number of SWAP gates is desirable, but computing the minimum number of SWAP gates required in a given circuit is an NP-Hard problem. Most techniques for transpiling quantum circuits are multi-pass heuristics, rather than exact. First, an initial set of transformations is used to translate the quantum circuit to a “native” gate set. Second, a heuristic mapping of logical qubits to physical qubits is suggested. Third, standard “circuit compression” transformations are applied in a Knuth-Bendix fashion, as discussed e.g. in K. Iwama et al. “Transformation rules for designing cnot-based quantum circuits”, Proceedings 2002 Design Automation Conference (IEEE Cat. No.02CH37324) (2002) pp. 419-424. An alternative approach to circuit compression based on the Yang-Baxter equation is described in B. Peng et al. “Quantum time dynamics employing the Yang-Baxter equation for circuit compression”, Phys. Rev. A 106, 012412 (2022).

### SUMMARY OF THE INVENTION

Embodiments of the invention aim to provide alternative approaches to circuit compression.

Aspects of the invention are set out in the independent claims. Certain preferred features are set out in the dependent claims.

Disclosed herein is a method of compressing a quantum circuit, comprising:
receiving data defining a quantum circuit, the quantum circuit including at least one section that matches a predetermined first arrangement of quantum gates, the first arrangement including a non-local interaction and being associated with a predetermined second arrangement of quantum gates that does not include the non-local interaction;
determining whether the circuit section meets a compression criterion;
in response to determining that the circuit section meets the compression criterion. modifying the circuit definition to replace the first arrangement of quantum gates with the second arrangement of quantum gates; and
outputting the modified circuit definition.

The non-local interaction preferably comprises a gate operating on non-adjacent qubits of the quantum circuit. The non-local interaction may be implemented (or implementable, e.g. would require implementation on the target quantum computer) using at least one SWAP gate. Thus, the input circuit may specify a non-local interaction that would ordinarily be implemented using one or more SWAP gates, or may specify the SWAP gates explicitly. For example, the circuit section may comprise at least one SWAP gate for implementing the non-local interaction, wherein the second arrangement does not include the at least one SWAP gate.

The described approach can enable circuit complexity to be reduced by eliminating expensive SWAP gates. Note that the term “SWAP gate” may refer to any gate serving to exchange the quantum states of two qubits.

Preferably, the first arrangement comprises one or more gates of a given gate type (e.g. in addition to any SWAP gates used to implement the non-local interaction). Determining whether the circuit section meets the compression criterion comprises determining whether the one or more gates meet a gate criterion, the gate criterion determining an equivalence between the first arrangement of quantum gates and the second arrangement of quantum gates. The equivalence is preferably defined by an equivalence equation, and determining whether the one or more gates meet the gate criterion comprises determining whether the one or more gates correspond to a solution of the equivalence equation. In particular, determining whether the one or more gates meet the gate criterion may comprise determining whether the one or more gates are fusion operators.

Preferably, determining whether the circuit section meets a compression criterion comprises determining whether the circuit section or the one or more gates correspond to a valid solution of a polygon equation, preferably the pentagon equation.

The compression criterion may comprise a predetermined set of evaluation criteria which may be associated with a set of gates in the first arrangement (and/or associated with a given gate type of the gates) and/or may be defined on parameters of the gates, the method comprising determining whether the parameters of the gates in the received circuit definition (that match the first arrangement) satisfy the evaluation criteria. The method may comprise identifying the gate type of one or more gates in the circuit section matching the first gate arrangement and selecting the evaluation criteria to be evaluated in dependence on the gate type. Preferably, the set of evaluation criteria comprises a set of equations, the equations preferably derived from the pentagon equation.

The second arrangement preferably comprises fewer gates than the first arrangement and/or has a shorter circuit depth.

Preferably, the method further comprising processing the received circuit definition to identify the section of the quantum circuit matching the first arrangement. This preferably includes identifying an arrangement of gates in the circuit that matches a circuit template specifying the first arrangement of gates. The method may comprise repeating the processing, determining and modifying steps one or more times, optionally until no further circuit sections matching the first arrangement are found.

The first arrangement may comprise two gates implementing local interactions between respective adjacent pairs of qubits in a quantum system of at least three qubits and a third gate implementing the non-local interaction between a non-adjacent pair of the qubits.

Optionally, the quantum circuit comprises at least three qubits, the first arrangement of gates comprising first and second SWAP gates arranged, respectively, before and after a further gate to implement an interaction between two non-adjacent ones of the three qubits. The first arrangement of gates then preferably comprises a further gate prior to the first SWAP gate providing an input to the first SWAP gate and/or a further gate subsequent to the second SWAP gate utilising an output of the second SWAP gate.

Preferably, the gates used in the first gate arrangement (other than SWAP gates), e.g. the further gate, the prior gate and the subsequent gate in the above example, are of a common gate type T, which may be one of: the A gate, and the evolution operator of the 1D Heisenberg model. In the above example, the second gate arrangement preferably eliminates both SWAP gates included in the first arrangement.

The second arrangement of gates is preferably functionally equivalent to the first arrangement of gates. The second arrangement preferably comprises two gates of the gate type T operating on respective adjacent pairs of the qubits.

Preferably, the first arrangement of quantum gates defined by the template is a gate arrangement as shown in arrangement 220 of FIG. 2B or as shown in FIG. 3A and/or the second arrangement of quantum gates is a gate arrangement as shown in arrangement 222 of FIG. 2B or as shown in FIG. 3B. The first and second arrangements of gates are preferably defined by respective sides of the pentagon equation, preferably defined as T₂₃T₁₂=T₁₂T₁₃T₂₃, wherein the first, uncompressed, gate arrangement is defined by T₁₂T₁₃T₂₃ and the second, compressed, gate arrangement is defined by T₂₃T₁₂, where T preferably represents gates used in the first/second arrangements and the indices 1-3 indicate respective qubits of a set three qubits on which the gates operate.

The method may further comprise outputting the modified circuit definition to a quantum transpiler for transpilation to a target quantum computer, wherein the transpiler outputs the compressed, transpiled circuit to a quantum controller for implementation on a quantum processing unit, or outputting the modified circuit definition to the quantum controller, and optionally executing the circuit defined by the modified circuit definition by the quantum controller using the quantum processing unit.

In a variant, which may include any of the optional or preferable features set out above, the method may be defined as a method of compressing a quantum circuit, comprising: receiving data defining a quantum circuit; identifying a section of the quantum circuit that matches a predetermined circuit template, wherein the circuit template specifies a first arrangement of quantum gates including at least one SWAP gate for implementing a non-local interaction and is associated with a predetermined second arrangement of quantum gates that does not include the SWAP gate; determining whether the circuit section meets a compression criterion; in response to determining that the circuit section meets the compression criterion; modifying the circuit definition to replace the first arrangement of quantum gates with the second arrangement of quantum gates; and outputting the modified circuit definition.

Also disclosed is a system having means, optionally comprising at least one computer device having a processor with associated memory, for performing any method as set out herein. The system may further comprise a quantum computer coupled to the computer device.

The disclosure also encompasses a computer program or tangible, non-transitory computer readable medium comprising software code adapted, when executed by a data processing system, to perform any method as set out herein.

Features of one aspect or example may be applied to other aspects or examples, in any combination. For example, method features may be applied to system or computer program aspects or examples (and vice versa).

### BRIEF DESCRIPTION OF THE FIGURES

Certain embodiments of the invention will now be described by way of example only, in relation to the Figures, wherein:

FIG. 1 illustrates a system for performing quantum circuit compression;

FIG. 2A illustrates local and non-local operations on a set of qubits;

FIG. 2B illustrates a mapping between a quantum circuit involving a non-local interaction and an equivalent compressed circuit;

FIG. 2C illustrates a SWAP operation used for implementing non-local interactions by swapping the quantum states of two qubits;

FIGS. 3A illustrate a circuit template defining a configuration of quantum gates to which compression may be applied in accordance with the described compression technique;

FIG. 3B illustrates a corresponding compressed circuit;

FIG. 4 illustrates a compression process;

FIG. 5 illustrates a process for determining whether compression can be applied to a particular circuit;

FIG. 6 illustrates equivalence between compressed and uncompressed quantum circuits;

FIG. 7 shows a circuit description of the 3-cocylce;

FIG. 8 shows a quantum circuit of the evolution operator of the 1D Heisenberg model;

FIGS. 9-10 show respective sets of equations used to determine compressibility for circuits employing the A-gate or the evolution operator of the 1D Heisenberg model; and

FIG. 11 illustrates a computer device for implementing the described circuit compression process.

### DETAILED DESCRIPTION

Embodiments of the invention provide a system for compressing quantum circuits. The system identifies sections of a quantum circuit that match a predetermined compression template. The compression template defines a compressible arrangement of quantum gates which maps to a functionally equivalent compressed gate arrangement with fewer gates and reduced circuit depth. as long as a compression criterion is fulfilled. The system evaluates sections of the circuit matching the template to determine whether they fulfil the compression criterion, and if so, replaces those sections with the equivalent compressed gate arrangement.

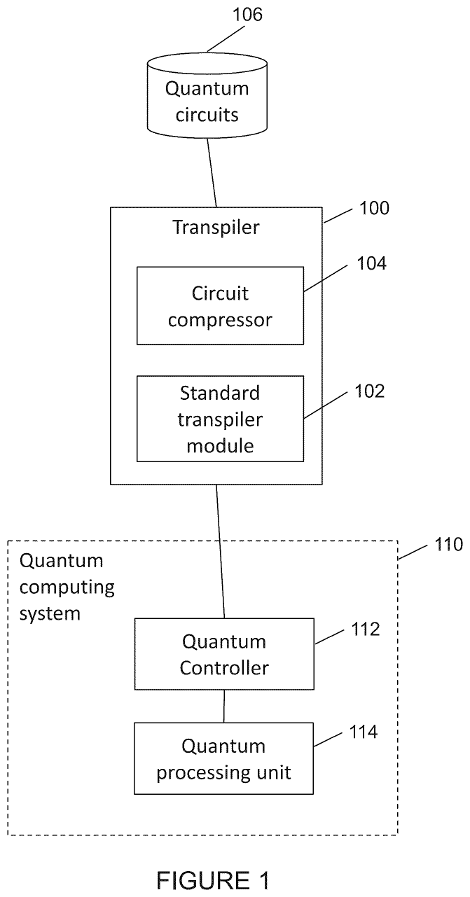

A system for implementing the described techniques is illustrated in FIG. 1.

The system includes a transpiler 100 used to prepare quantum circuits for execution on a quantum system 110. Quantum circuits define quantum computations to be carried out by a quantum computer by specifying sequences of quantum computing operations, defined as an arrangement of quantum gates, to be applied to one or more qubits in a quantum processing unit to alter the state of those qubits. Examples of quantum gates include the Hadamard gate, the phase shift gate, the SWAP gate and the CNOT (controlled-NOT) gate.

Quantum circuits may be stored, for example, in a circuit database 106. Quantum circuits may be defined using the QASM (Quantum Assembler) language or a variant of that language.

Transpilation refers to adapting and/or optimizing a particular quantum circuit to the topology of a quantum computing device that will be used to “run” the circuit. The transpiler 100 reads a circuit (e.g. in the form of a QASM file) and processes it to make it suitable for execution on the target quantum computing system 110. For example, this may involve re-expressing operations defined using certain types of gates using a different set of gates that can be implemented on the target hardware. For example, a SWAP gate may be implemented on a particular quantum computer as a set of CNOT gates.

In an embodiment, the transpiler includes a standard transpiler module 102 and a circuit compressor 104.

Circuit compressor 104 identifies circuits (or parts of circuits) that can be compressed by replacing certain non-local gate operations with equivalent expressions using local interactions. Eliminating non-local operations can remove the need for expensive SWAP operations.

The standard transpiler module 102 performs conventional processes for transpiling to the chosen quantum hardware, as known in the art. If no adaptation to the target hardware is required (e.g. because the input circuit is already suitable for execution on the target hardware) then the standard transpiler module may be omitted or bypassed.

After circuit compression and any other required transpilation steps, the transpiler 100 provides the compressed and transpiled circuit to a quantum computing system 110 for execution. The quantum computing system includes a quantum controller 112 which controls execution of the quantum circuits on a quantum processing unit 114. Any suitable gate-based quantum computing hardware may be used to implement quantum computing system 110. In certain embodiments, the quantum computing system comprises an IBM® quantum computer (e.g. Osprey®) or a Rigetti Aspen M-2® quantum computer.

While circuit compressor 104 is shown in FIG. 1 as a module of transpiler 100, it could alternatively be implemented separately, e.g. as a circuit pre-processor that pre-processes quantum circuits and performs compression if possible. In this case, the compressor 104 could, for example, operate on a circuit defined in QASM language and output a compressed circuit also expressed in QASM language which could then be stored in data store 106 for later execution or passed directly to the transpiler.

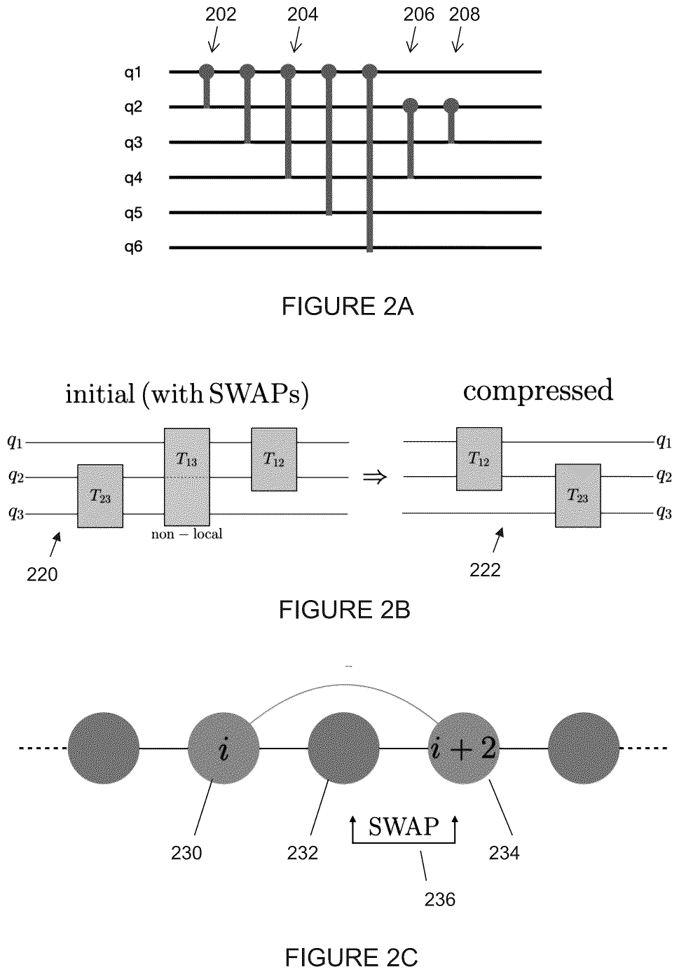

FIG. 2A shows a schematic illustration of local and non-local operations on a quantum system of six qubits. Local operations, such as operation 202 involving qubits q1 and q2, and operation 208 involving qubits q2 and q3 are typically more efficient than non-local operations, such as operation 204 involving qubits q1 and q4 and operation 206 involving qubits q2 and q4. Implementation of such non-local operations typically requires SWAP gates which can be expensive to implement.

Embodiments of the invention provide a circuit compressor that can for some circuits convert a given circuit into an equivalent circuit that eliminates a non-local interaction. An example is shown in FIG. 2B, where an input circuit 220 is shown that includes three gates T₂₃, T₁₃ and T₁₂ (where the subscripts indicate the qubits q₁ . . . 9₃ to which operations are applied). The compressor converts this into a functionally equivalent circuit 222 eliminating the non-local operation.

Non-local operations are commonly implemented using SWAP gates. A SWAP gate exchanges quantum states between two qubits. Addition of such a swap operation can thus allow a non-local operation to be carried out as a local operation. FIG. 2C illustrates application of a swap gate to an interaction involving qubits i (230) and i+2 (234).

The swap operation exchanges the quantum state between qubits i+1 (232) and i+2 (234). A local interaction can then be performed involving qubits i (230) and i+1 (232).

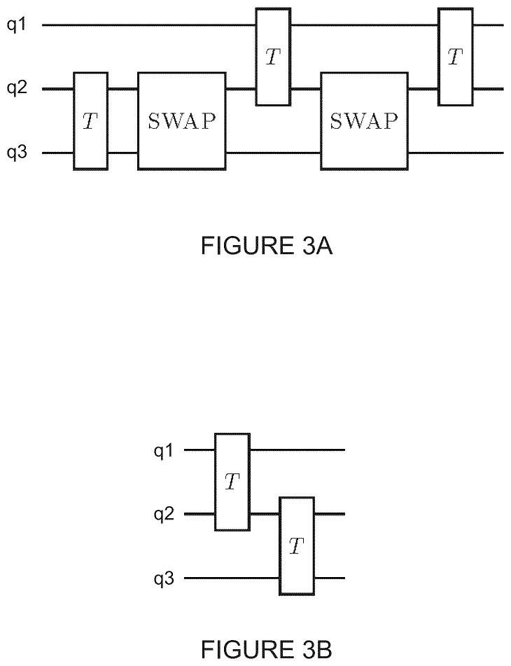

FIGS. 3A and 3B schematically illustrate a circuit template (FIG. 3A) including non-local interactions implemented using two swap gates and an equivalent compressed circuit (FIG. 3B) in which non-local interactions and the associated swap gates have been eliminated. Here, T represents a given type of gate that may appear in the input circuit and for which compression according to the template may be possible. The gates T are parameterized and are defined by Ising-type Hamiltonians. In the present examples, the gate types that support compression are A-gates and evolution operators of the 1D Heisenberg model as described in more detail later. The circuit compressor attempts to match an input circuit to the template shown in FIG. 3A and substitute it with the equivalent compressed circuit shown in FIG. 3B, as long as the parameterized gates T utilised in the matched circuit meet a compressibility criterion which ensures equivalence of the uncompressed and compressed circuits.

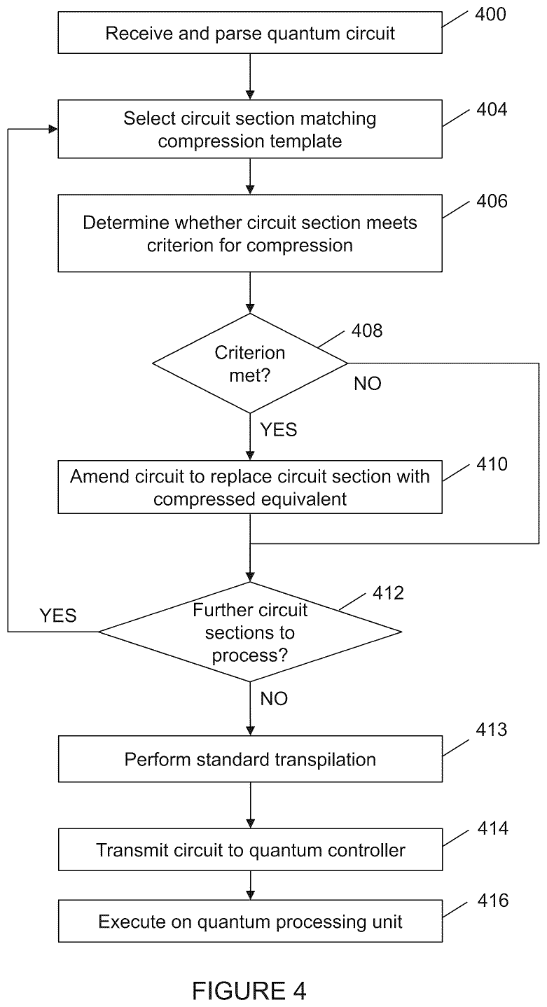

FIG. 4 illustrates a method for compressing a quantum circuit as performed by the circuit compressor 104.

In step 400, a specification of a quantum circuit is received. For example, this may be retrieved from database 106 and may be expressed in the QASM language or another suitable form. The circuit specification is parsed to generate a data representation of the circuit.

In step 404, a section of the circuit is identified that includes an arrangement of quantum gates matching the compression template (as shown in FIG. 3A). This may involve iteratively comparing sections of the circuit against the template until a match is found.

In step 406, the process evaluates the identified circuit section to determine whether it meets certain criteria for compression. In particular, this involves determining whether the particular gates used in the circuit in place of the gate placeholders T of the template meet a predetermined gate criterion. The criterion is based on evaluation of the gate parameters against a set of equations as described in more detail below.

If the evaluation determines that the compression criterion is met (test 408) and therefore compression is possible, then in step 410, the circuit is modified to replace the arrangement of gates that was matched to the template (FIG. 3A) with the equivalent arrangement of gates defined by the compressed circuit of FIG. 3B, thereby providing an alternative circuit that eliminates the SWAP gates.

The process then determines in step 412 whether there are further parts of the circuit to process. If so, the process continues to step 404 to continue evaluating the circuit to search for further matches to the template.

If in step 408, it is determined that the part of the circuit being evaluated does not meet the compression criterion, then step 410 is bypassed and the process continues directly to step 412 to consider other parts of the circuit, without rewriting this part of the circuit.

In step 413, once all potentially compressible parts of the circuit have been processed (test 412, NO branch), the resulting modified (compressed) quantum circuit is transpiled to the target hardware as required, using standard transpiler module 102.

The transpiled circuit is then sent in step 414 to the quantum controller 112 of quantum computing system 110, which executes the circuit on the quantum processing unit 114 in step 416. To execute the circuit, the quantum controller compiles the gate operations of the quantum circuit using a quantum compiler into control signals for the quantum processing unit (alternatively, the quantum compiler may be implemented as a separate component). The processing operations defined by the quantum circuit are then carried out by application of the control signals to the system of qubits of the quantum processing unit.

Instead of immediate execution, the compressed and/or transpiled circuit could alternatively be stored (e.g. in circuit database 106) for later execution.

Compression is based on the pentagon equation. The pentagon equation belongs to an infinite family of equations called polygon equations, and is similar to the Yang-Baxter equation. It appears in various branches of mathematics, such as representation theory, topological field theory and conformal field theory.

In the present system, the pentagon equation is used to define an equivalence between certain circuits, specifically between circuits matching the circuit arrangements 220 and 222 of FIG. 2B, or equivalently between the compression template of FIG. 3A explicitly showing the SWAP gates and the corresponding compressed circuit without SWAP gates of FIG. 3B.

The pentagon equation is defined as follows. Note that in these equations, V is used to denote a finite dimensional vector space over the complex numbers with the usual tensor product of vector spaces ⊗. The identity map from V to V is denoted id_{V} and the twist map τ_{V,V}: V⊗V→V⊗V reads x⊗y [symbol] y⊗x. A linear map f: U→V, between two vector spaces U and V, has an associated matrix with respect a basis of U and V. For convenience, the linear map and its associated matrix are associated by the same letter.

Thus, with V defining a finite dimensional vector space and T: V⊗V→V⊗V defining a linear map, the following maps are defined:

$${T}_{12} , {T}_{23} , {T}_{13} : V ⊗ V ⊗ V \to V ⊗ V ⊗ V$$

by the formulae:

$$\begin{matrix}{T}_{12} := T ⊗ i {d}_{V} \\ {T}_{23} := {id}_{V} ⊗ T \\ {T}_{13} := {( i {d}_{V} ⊗ {τ}_{V , V} )}^{- 1} ∘ ( T ⊗ i {d}_{V} ) ∘ ( {id}_{V} ⊗ {τ}_{V , V} )\end{matrix} .$$

The pentagon equation is then defined by:

$${T}_{23} {T}_{12} = {T}_{12} {T}_{13} {T}_{23} .$$

FIG. 2B depicts the corresponding equivalence between uncompressed and compressed circuits. In the equation, the left-hand side corresponds to the compressed circuit and the right-hand side defines the uncompressed circuit. As illustrated in FIG. 2B, T₁₂ corresponds to a gate involving a local interactions between qubits q₁ and q₂, T₂₃ corresponds to a gate involving a local interaction between qubits q₂ and q₃, and T₁₃ corresponds to a gate implementing a non-local interaction between qubits q₁ and q₃. The non-local operation is typically implemented using a series of SWAP gates, resulting in the corresponding circuit template of FIG. 3A.

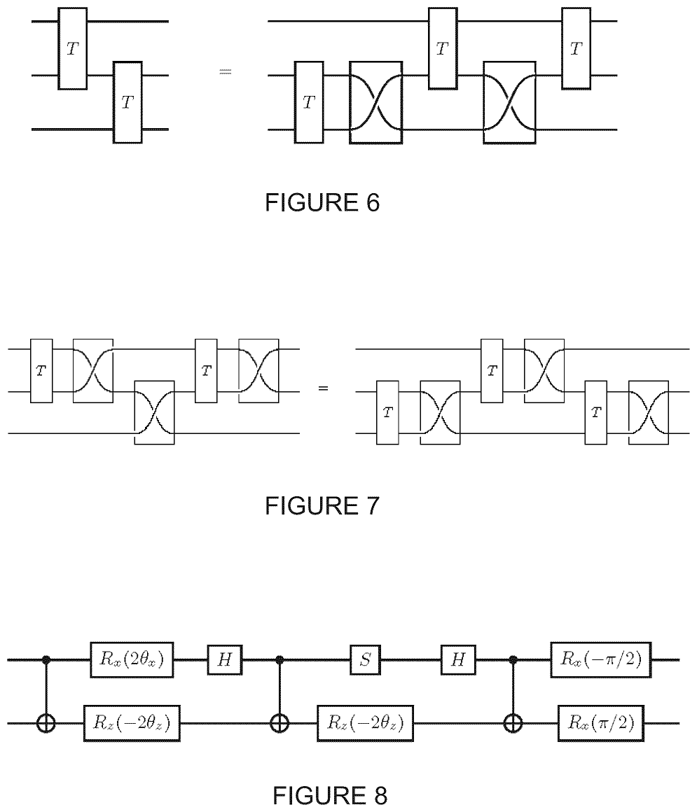

FIG. 6 depicts the pentagon equation as a quantum circuit. Twisting the quantum wires is implemented by enforcing non-local interactions. It is generally assumed herein that quantum wire twist is implemented using SWAP gates. However, even within the landscape of NISQ devices, e.g. in certain neutral atom architectures, it is possible to implement the twist by directly applying appropriate microwave pulses.

A solution of the pentagon equation is a linear operator T which satisfies this equation. Solutions of the pentagon equations are commonly referred to as fusion operators.

By way of background, one way to produce fusion operators, i.e. solutions of the pentagon equation, is from a bialgebra. A bialgebra B is a vector space with an algebra structure and a compatible coalgebra structure. Denote by m the product of the algebra and by θₓ+θ_{y} the coproduct of the coalgebra. Then, the composite map T:=(id⊗m)∘(δ⊗id) is a fusion operator (for more details, see R. Street, “Fusion operators and cocycloids in monoidal categories”, Appl. Categ. Structures 6, 177, 1998).

Fusion operators can be identified as follows. For a linear map T: V⊗V→V⊗V, Tis a fusion operator if and only if T′:=τ_{V,V}∘T satisfies the 3-cocycle condition

$$( {T}^{′} ⊗ {id}_{V} ) ∘ ( i {d}_{V} ⊗ {τ}_{V , V} ) ∘ ( {T}^{′} ⊗ {id}_{V} ) = ( i {d}_{A} ⊗ {T}^{′} ) ∘ ( {T}^{′} ⊗ {id}_{V} ) ∘ ( i {d}_{V} ⊗ {T}^{′} )$$

The circuit description of the 3-cocycle is shown in FIG. 7. The easiest way to implement this type of circuit, should a fusion operator T exist, is to use a SWAP gate. As noted above, it is assumed herein that the quantum wire twist is indeed implemented using SWAP gates. However, in certain architectures, for example in the case of analog neutral atom approaches, it is possible to directly implement such a twist when indeed one is interested in the next-to-nearest-neighbor interactions.

The pentagon equation makes it possible to transpile a certain quantum circuit with five gates (matching the compression template of FIG. 3A), in which the twist of the quantum wires is implemented using SWAP gates, into a quantum circuit with two gates (as shown in FIG. 3B), resulting in a significant reduction in gate count (especially in architectures where SWAP gates are implemented using multiple CNOT gates).

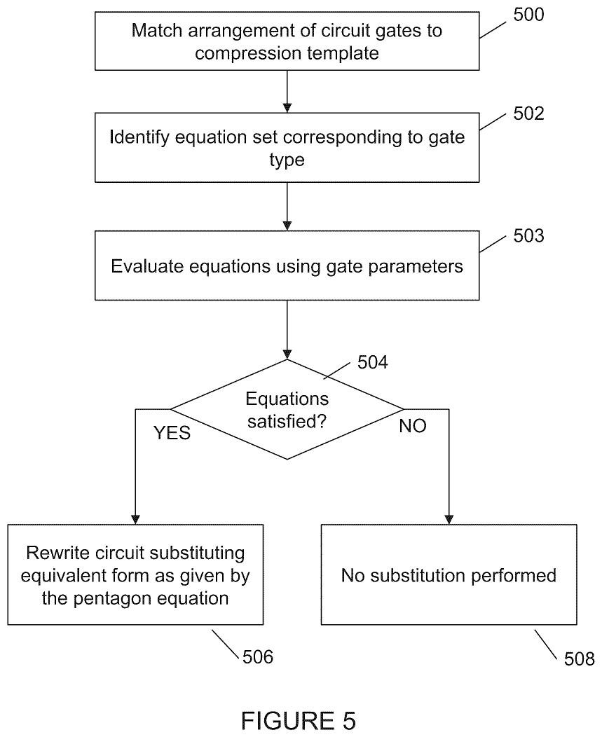

FIG. 5 illustrates the compression process for a particular circuit section in more detail.

In step 500, the process matches an arrangement of circuit gates of the input circuit to the compression template. The compression template has the form depicted in FIG. 3A. To identify the matching circuit section, the process searches the circuit definition until an arrangement of gates matching the template is found.

Note that this example assumes that the input explicitly defines the SWAP gates. Alternatively, the input circuit may merely specify the non-local interaction as an interaction between non-adjacent qubits (without explicitly defining the SWAP gates that would be needed to implement the non-local interaction). In that case, the process may instead try to match an arrangement of gates of the input circuit to a template comprising the arrangement 220 of FIG. 2B, specifying the non-local interaction T₁₃ explicitly.

When a section of the circuit has been matched to the template, the process then determines whether the circuit section corresponds to a valid solution of the pentagon equation.

As noted above, for a unitary gate T and a quantum circuit which contains a sub-circuit matching the compression template shown in FIG. 2B or 3A, if T satisfies the pentagon equation, then the sub-circuit can be replaced by the corresponding circuit shown in FIG. 3B (which is equivalent to arrangement 222 of FIG. 2B).

Application of this test will be described in relation to specific gate examples further below. In overview, each particular type of gate is characterised by a set of equations, derived from the pentagon equation. As noted above, the gates T are parameterized and the equations for that gate type are evaluated based on the gate parameters specified in the circuit. The gates of the circuit satisfy the pentagon equation if and only if the associated set of equations are satisfied.

Thus, in order to evaluate a particular circuit that matches the FIG. 2B/FIG. 3A template using a particular gate T, the system retrieves the equation set for the appropriate gate type in step 502. Each equation defines an equality and the system performs the necessary computations to evaluate the equations using the parameter values specified for each gate in the matched sub-circuit in step 503 to check whether each equality holds true. If all equations of the set are satisfied in this way, then the gates, and hence the matched circuit section, satisfy the pentagon equation. If any of the equations do not hold, then the circuit section is considered to have failed the compressibility evaluation.

If the equations are satisfied and the circuit therefore corresponds to a valid solution (test 504), then the process modifies the circuit to rewrite the circuit section being compressed in step 506. This involves replacing the circuit section that matches the template (as depicted in FIG. 2B arrangement 220 or FIG. 3A) with the corresponding compressed circuit as depicted in FIG. 2B arrangement 222 or FIG. 3B (with T substituted for the relevant gate type used in the circuit). This replacement produces an equivalent circuit since, by definition, the pentagon equation defines an equality between the two circuits (as also depicted in FIG. 6), if (and only if) the gates represented in the template by the placeholder T in fact correspond to a valid solution to the pentagon equation.

If the gates (and hence the matched circuit section) do not correspond to a valid solution of the pentagon equation, then the process terminates and no substitution is performed (step 508), i.e. the circuit is not modified.

Note that, where compression is possible, the substitution with the equivalent compressed circuit is performed in accordance with the pentagon equation, T₂₃T₁₂=T₁₂T₁₃T₂₃ (as introduced above). The right-hand side of the equation, T₁₂T₁₃T₂₃, defines the circuit prior to compression, where non-local interaction T₁₃ is implemented (or would be implemented) in the actual circuit as per the FIG. 3A template as a local interaction (the middle T gate) using SWAP operations. Thus, assuming the gate parameters for the three gates, corresponding to gates T₁₂, T₁₃ and T₂₃ of the pentagon equation, satisfy the relevant equations, then the compressed circuit is created as per FIG. 2B arrangement 222/FIG. 3B, using the gates T₂₃ and T₁₂ with their associated parameters.

The compression can serve to reduce the complexity of the overall circuit by reducing the number of gates, resulting in shorter circuit depth, and also eliminating non-local interactions by using gates operating on adjacent qubits.

Returning to FIG. 4, the above process may be repeated to evaluate, and if appropriate substitute, any circuit section that matches the template and meets the compression criterion based on the pentagon equation. Once the entire circuit has been processed, the compression may result in a compressed circuit with one or more substituted circuit sections, or the circuit may be unaltered if no circuit section matched the template or substitution was not possible for any matching sections.

### Examples for Specific Gate Types

The following section considers the pentagon equation in the context of the A gate and the evolution operator of the 1D Heisenberg model. The A gate and the evolution operator of the 1D Heisenberg model for N=2 are both solutions of the pentagon equation subject to a number of constraining equations and details are set out below. However, first, some background is provided.

### Background

The Pauli matrices σₐ, a∈{x, y, z} which are the generators of the Lie algebra [symbol] (2) of the Lie group SU(2) read

$${σ}_{x} = ( \begin{matrix}0 & 1 \\ 1 & 0\end{matrix} ) , \qquad {σ}_{y} = ( \begin{matrix}0 & - i \\ i & 0\end{matrix} ) , \qquad {σ}_{z} = ( \begin{matrix}1 & 0 \\ 0 & - 1\end{matrix} ) ,$$

where i is the imaginary unit. It is worth mentioning here that σₓ²=σ_{y}²=_{z}²= [symbol] . Based on this fact, one computes

$$exp ( i θ {σ}_{a} ) = cos ( θ ) + sin ( θ ) {σ}_{a} ,$$

for a=x, y, z and θ∈ [symbol] . Precisely, the matrix exponentials of σₓ, σ_{y} and σ_{z} give rise to the rotation operator matrices Rₓ(θ), R_{y}(θ) and R_{z}(θ) respectively which read

$$\begin{matrix}{R}_{x} ( θ ) = ( \begin{matrix}cos ( θ / 2 ) & - i sin ( θ / 2 ) \\ - i sin ( θ / 2 ) & cos ( θ / 2 )\end{matrix} ) , \\ {R}_{y} ( θ ) = ( \begin{matrix}cos ( θ / 2 ) & sin ( θ / 2 ) \\ sin ( θ / 2 ) & cos ( θ / 2 )\end{matrix} ) , \\ {R}_{z} ( θ ) = ( \begin{matrix}{e}^{- i θ / 2} & 0 \\ 0 & {e}^{- i θ / 2}\end{matrix} ) .\end{matrix}$$

### Standard Gates

A quantum circuit is a series of unitary transformations, called gates, which act on qubits. Gates referenced in this document include the Hadamard gate H and the phase shift gate S which are applied to single qubits and read respectively

$$H = \frac{1}{\sqrt{2}} ( \begin{matrix}1 & 1 \\ 1 & - 1\end{matrix} ) , \qquad S = ( \begin{matrix}1 & 0 \\ 0 & i\end{matrix} ) .$$

The controlled NOT gate, denoted by CNOT, and the SWAP gate are applied to 2-qubits and read respectively

$$CNOT = ( \begin{matrix}1 & 0 & 0 & 0 \\ 0 & 1 & 0 & 0 \\ 0 & 0 & 0 & 1 \\ 0 & 0 & 1 & 0\end{matrix} ) \qquad SWAP = ( \begin{matrix}1 & 0 & 0 & 0 \\ 0 & 0 & 1 & 0 \\ 0 & 1 & 0 & 0 \\ 0 & 0 & 0 & 1\end{matrix} )$$

### The A and B Gates

While there are many standard gates, it would be convenient to reason about all nonlocal two-qubit operations at the same time, while considering as few parameters as possible. To do so, Zhang et al. in “Minimum construction of two-qubit quantum operations”, Phys. Rev. Lett. 93, 020502 (2004), introduced the three-parameter model, where each choice of the three parameters corresponds to a local equivalence class of two-qubit gates up to Weyl reflection symmetries. In particular, the model is defined as the product of the unitary matrices

$$XX ( {c}_{1} ) := {e}^{i \frac{{c}_{1}}{2} {σ}_{x} ⊗ {σ}_{x}} , YY ( {c}_{2} ) := {e}^{i \frac{{c}_{2}}{2} {σ}_{y} ⊗ {σ}_{y}} and ZZ ( {c}_{3} ) := {e}^{i \frac{{c}_{3}}{2} {σ}_{z} ⊗ {σ}_{z}}$$

where

$$\begin{matrix}XX ( {c}_{1} ) = ( \begin{matrix}cos ( {c}_{1} / 2 ) & 0 & 0 & i sin ( {c}_{1} / 2 ) \\ 0 & cos ( {c}_{1} / 2 ) & i sin ( {c}_{1} / 2 ) & 0 \\ 0 & i sin ( {c}_{1} / 2 ) & cos ( {c}_{1} / 2 ) & 0 \\ i sin ( {c}_{1} / 2 ) & 0 & 0 & cos ( {c}_{1} / 2 )\end{matrix} ) , \\ YY ( {c}_{2} ) = ( \begin{matrix}cos ( {c}_{2} / 2 ) & 0 & 0 & - i sin ( {c}_{2} / 2 ) \\ 0 & cos ( {c}_{2} / 2 ) & i sin ( {c}_{2} / 2 ) & 0 \\ 0 & i sin ( {c}_{2} / 2 ) & cos ( {c}_{2} / 2 ) & 0 \\ - i sin ( {c}_{2} / 2 ) & 0 & 0 & cos ( {c}_{2} / 2 )\end{matrix} ) , \\ ZZ ( {c}_{3} ) = ( \begin{matrix}{e}^{i {c}_{3} / 2} & 0 & 0 & 0 \\ 0 & {e}^{- i {c}_{3} / 2} & 0 & 0 \\ 0 & 0 & {e}^{- i {c}_{3} / 2} & 0 \\ 0 & 0 & 0 & {e}^{i {c}_{3} / 2}\end{matrix} ) .\end{matrix}$$

An analytic form of the A gate, where c₁, c₂, c₃ are integer coefficients is shown below:

$$A = ( \begin{matrix}{e}^{\frac{i {c}_{3}}{2}} cos ( \frac{1}{2} ( {c}_{1} - {c}_{2} ) ) & 0 & 0 & i {e}^{\frac{i {c}_{3}}{2}} sin ( \frac{1}{2} ( {c}_{1} - {c}_{2} ) ) \\ 0 & {e}^{- \frac{i {c}_{3}}{2}} cos ( \frac{1}{2} ( {c}_{1} + {c}_{2} ) ) & i {e}^{- \frac{i {c}_{3}}{2}} sin ( \frac{1}{2} ( {c}_{1} + {c}_{2} ) ) & 0 \\ 0 & i {e}^{- \frac{i {c}_{3}}{2}} sin ( \frac{1}{2} ( {c}_{1} + {c}_{2} ) ) & {e}^{- \frac{i {c}_{3}}{2}} cos ( \frac{1}{2} ( {c}_{1} + {c}_{2} ) ) & 0 \\ i {e}^{\frac{i {c}_{3}}{2}} sin ( \frac{1}{2} ( {c}_{1} - {c}_{2} ) ) & 0 & 0 & {e}^{\frac{i {c}_{3}}{2}} cos ( \frac{1}{2} ( {c}_{1} - {c}_{2} ) )\end{matrix} )$$

Associated with the model, but not as important for our considerations, is the B gate which reads

$$B = {e}^{\frac{π i}{4} {σ}_{x}^{1} ⊗ {σ}_{x}^{2}} \cdot {e}^{\frac{π i}{8} {σ}_{y}^{1} ⊗ {σ}_{y}^{2}} .$$

The B gate is related to the A gate as A ˜BUB, for some U∈U(2)×U(2) (see J. Zhang et al. “Geometric theory of nonlocal two-qubit operations”, Phys. Rev. A 67, 042313 (2003)).

### The 1D Heisenberg Model

The Heisenberg model is a spin model of ferromagnetism on a lattice where the coupling energy/between nearest neighbor lattice sites is positive and parallel alignment of local spins is favorable. The variables in the Heisenberg model are subject to a continuous internal symmetry which once broken to [symbol] it yields the Ising model which is quite commonly used in the context of Variational Quantum Algorithms (VQAs). Both the Heisenberg and the Ising models are of particular interest in the theory of quantum integrability precisely due to their integrable nature; they satisfy certain equations for which one can find analytic solutions at any value of the coupling energy/and the thermodynamic limit N→∞, where N is the number of lattice sites or spins.

In this context, we are interested especially in the 1D Heisenberg model with N=2. This is a case of particular interest since it is the only scenario where the components of the model's Hamiltonian commute. The Heisenberg Hamiltonian is defined as

$$\hat{H} = - {\sum }_{a} {J}_{a} ( {σ}_{1}^{a} ⊗ {σ}_{2}^{a} )$$

where a∈{x, y, z}, σ^{a} is the Pauli matrix at the direction of a, Jₐ is the coupling constant or interaction strength. The evolution operator of the Shrödinger equation is e^{iĤt/ℏ}. An analytic form of the evolution operator of the Shrödinger equation is shown below:

$${e}^{i \hat{H} L / ℏ} = {\prod }_{a} {e}^{{iJ}_{a} t ( {σ}_{1}^{a} ⊗ {σ}_{2}^{a} ) / ℏ} = ( \begin{matrix}{e}^{i {θ}_{z}} cos ( {θ}_{x} - {θ}_{y} ) & 0 & 0 & i {e}^{i {θ}_{z}} sin ( {θ}_{x} - {θ}_{y} ) \\ 0 & {e}^{- i {θ}_{z}} cos ( {θ}_{x} + {θ}_{y} ) & i {e}^{- i {θ}_{z}} sin ( {θ}_{x} + {θ}_{y} ) & 0 \\ 0 & i {e}^{- i {θ}_{z}} sin ( {θ}_{x} + {θ}_{y} ) & {e}^{- i {θ}_{z}} cos ( {θ}_{x} + {θ}_{y} ) & 0 \\ i {e}^{- i {θ}_{z}} sin ( {θ}_{x} - {θ}_{y} ) & 0 & 0 & {e}^{- i {θ}_{z}} cos ( {θ}_{x} - {θ}_{y} )\end{matrix} )$$

Notice that γ=θₓ−θ_{y} and θₓ+θ_{y}=θₓ+θ_{y} is based on a calculation of the individual components:

$$\begin{matrix}{e}^{{iJ}_{x} t ( {σ}_{1}^{x} ⊗ {σ}_{2}^{x} ) / ℏ} = ( \begin{matrix}cos ( {θ}_{x} ) & 0 & 0 & sin ( {θ}_{x} ) \\ 0 & cos ( {θ}_{x} ) & i sin ( {θ}_{x} ) & 0 \\ 0 & i sin ( {θ}_{x} ) & cos ( {θ}_{x} ) & 0 \\ i sin ( {θ}_{x} ) & 0 & 0 cos ( {θ}_{x} ) & \end{matrix} ) \\ {e}^{{iJ}_{y} t ( {σ}_{1}^{y} ⊗ {σ}_{2}^{y} ) / ℏ} = ( \begin{matrix}cos ( {θ}_{x} ) & 0 & 0 & - i sin ( {θ}_{y} ) \\ 0 & cos ( {θ}_{y} ) & i sin ( {θ}_{y} ) & 0 \\ 0 & i sin ( {θ}_{y} ) & cos ( {θ}_{y} ) & 0 \\ - i sin ( {θ}_{y} ) & 0 & 0 & cos ( {θ}_{y} )\end{matrix} ) \\ {e}^{{iJ}_{z} t ( {σ}_{1}^{z} ⊗ {σ}_{2}^{z} ) / ℏ} = ( \begin{matrix}{e}^{i} {θ}_{z} & 0 & 0 & 0 \\ 0 & {e}^{- i} {θ}_{z} & 0 & 0 \\ 0 & 0 & {e}^{- i} {θ}_{z} & 0 \\ 0 & 0 & 0 & {e}^{- i} {θ}_{z}\end{matrix} )\end{matrix} .$$

The matrix e^{iĤt/ℏ} is obtained from the A gate by setting c₁=2(θₓ−θ_{y}), c₂=2(θₓ+θ_{y}) and c₃=2θ_{z} in matrix A.

The evolution operator of the 1D Heisenberg model as a quantum circuit is shown in FIG. 8.

### Compressing Circuits using the A Gate or the Evolution Operator of the 1D Heisenberg Model

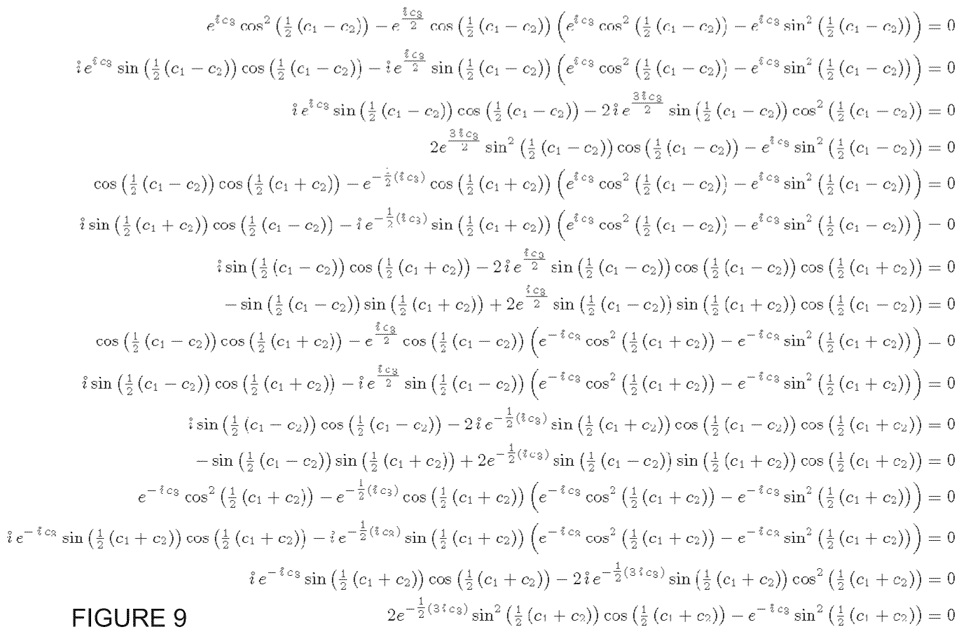

As discussed above, the circuit mapping between circuits as depicted in FIG. 2B and FIGS. 3A-3B provides a way to transpile a quantum circuit assuming that the unitary gate T is a fusion operator. The A-gate satisfies the pentagon equation and hence the described approach can be applied to transpiling a quantum circuit for specific values of its coefficients c₁, c₂ and c₃. More precisely, the A-gate, as defined above, satisfies the pentagon equation if and only if the equations shown in FIG. 9 are satisfied (where c₁, c₂ and c₃ are the gate parameters).

The system of equations is obtained by substituting the gate A into the pentagon equation and equating both sides. Solving the equations one obtains c₁=c₂=0 and c₃=−2πk where k∈ [symbol] .

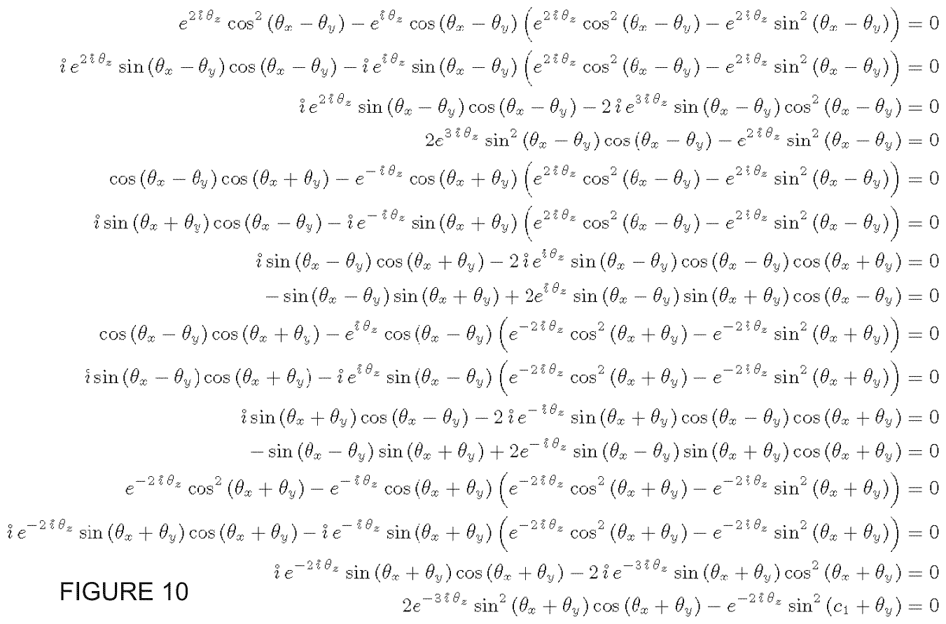

Based on the relation of the matrix A and the evolution operator of the 1D Heisenberg model, the following can be stated: The evolution operator of the 1D Heisenberg model for N=2 (as defined above) is a solution of the pentagon equation if and only if the equations in FIG. 10 are satisfied (where θₓ, θ_{y} and θ_{z} are the gate parameters). That is the case, where θₓ=θ_{y}=0 and θ_{z}=−kπ for k∈ [symbol] .

The system of equations of FIG. 10 is obtained by substituting the evolution operator of the 1D Heisenberg model into the pentagon equation and equating both sides. Solving those equations gives the values for the coefficients θₓ, θ_{y} and θ_{z}.

The described techniques can thus allow a quantum circuit composed of 2-qubit interactions that include nonlocal interactions to be compressed to a local interactions only quantum circuit if the corresponding gates are fusion operators, that is, for a particular set of parameters that satisfy the constraining equations. This compression can have a substantial impact by reducing the corresponding number of SWAP gates when direct non-nearest neighbor interactions are not possible.

### Processing Device

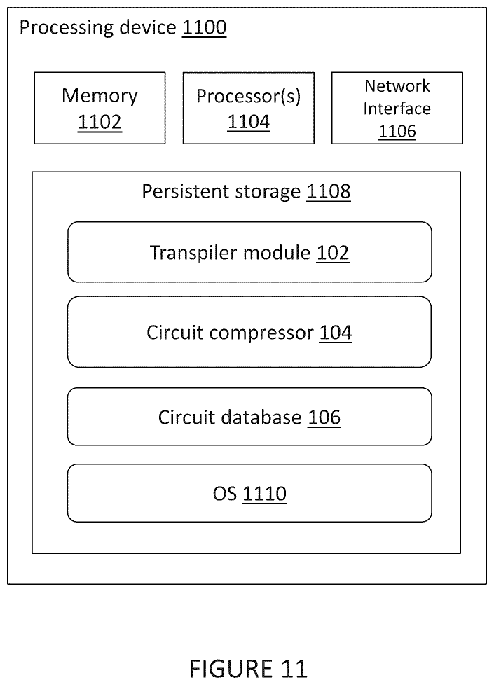

FIG. 11 illustrates a processing device (in the form of a classical, i.e. non-quantum computer) for implementing the transpiler 100 of FIG. 1.

The processing device 1100 may be based on conventional workstation or server hardware and as such includes one or more processors 1104 together with volatile/random access memory 1102 for storing temporary data and software code being executed.

A network interface 1106 is provided for communication with other system components. For example, the processing device may communicate via the network interface with the external quantum circuit database 106 and with the quantum computing system 110 (to run quantum circuits on the quantum processing unit 114 via the quantum controller 112). Communication may occur over one or more networks (e.g. Local and/or Wide Area Networks, including private networks and/or public networks such as the Internet).

In an embodiment, the quantum computing system may be provided as a remote system, accessible via a cloud-based quantum computing service.

Persistent storage 1108 (e.g. in the form of hard disk storage, optical storage and the like) persistently stores software and data for performing various described functions. In an example, this includes a transpiler module 102 implementing conventional transpiler functions and a circuit compressor module 104 for implementing the described circuit compression techniques. The circuit database 106 may also be stored within the persistent storage, to store input circuits to be compressed and compressed output circuits.

The persistent storage further includes a computer operating system 1110 and any other software and data needed for operating the processing device. The device will include other conventional hardware components as known to those skilled in the art, and the components are interconnected by one or more data buses (e.g. a memory bus and I/O bus).

While a specific architecture is shown and described by way of example, any appropriate hardware/software architecture may be employed to implement the transpiler system.

Furthermore, functional components indicated as separate may be combined and vice versa. For example, the various functions may be performed by a single device 1100 or may be distributed across multiple devices. As a concrete example, the circuit database 106 could be stored at a separate data repository e.g. a database server.

It will be understood that the present invention has been described above purely by way of example, and modification of detail can be made within the scope of the invention.

1. A method of compressing a quantum circuit, comprising:
receiving data defining a quantum circuit, the quantum circuit including at least one section that matches a predetermined first arrangement of quantum gates, the first arrangement including a non-local interaction and being associated with a predetermined second arrangement of quantum gates that does not include the non-local interaction;
determining whether the circuit section meets a compression criterion;
in response to determining that the circuit section meets the compression criterion, modifying the circuit definition to replace the first arrangement of quantum gates with the second arrangement of quantum gates; and
outputting the modified circuit definition.

2. A method according to claim 1, wherein the non-local interaction comprises at least one of:
a gate operating on non-adjacent qubits of the quantum circuit;
a non-local interaction implemented using at least one SWAP gate.

3. (canceled)

4. A method according to claim 1, wherein the circuit section comprises at least one SWAP gate for implementing the non-local interaction, and wherein the second arrangement does not include the at least one SWAP gate.

5. A method according to claim 1, wherein the first arrangement comprises one or more gates of a given gate type, wherein determining whether the circuit section meets the compression criterion comprises determining whether the one or more gates meet a gate criterion, the gate criterion determining an equivalence between the first arrangement of quantum gates and the second arrangement of quantum gates.

6. A method according to claim 5, wherein the equivalence is defined by an equivalence equation, and wherein determining whether the one or more gates meet the gate criterion comprises determining whether the one or more gates correspond to a solution of the equivalence equation.

7. A method according to claim 5, wherein determining whether the one or more gates meet the gate criterion comprises determining whether the one or more gates are fusion operators and/or wherein determining whether the circuit section meets a compression criterion comprises determining whether the one or more gates correspond to a valid solution of the pentagon equation.

8. (canceled)

9. A method according to claim 1, wherein the compression criterion comprises a predetermined set of evaluation criteria associated with a set of gates in the first arrangement and defined on parameters of the gates, the method comprising determining whether the parameters of the gates in the received circuit definition satisfy the evaluation criteria, comprising identifying the gate type of one or more gates in the circuit section matching the first gate arrangement, and selecting the evaluation criteria to be evaluated in dependence on the gate type.

10. (canceled)

11. A method according to claim 9, wherein the set of evaluation criteria comprises a set of equations, the equations preferably derived from the pentagon equation.

12. A method according to claim 1, wherein the second arrangement comprises at least one of:
an arrangement of gates having fewer gates than the first arrangement and/or has having a shorter circuit depth;
an arrangement of gates that is functionally equivalent to the first arrangement of gates.

13. A method according to claim 1, further comprising processing the received circuit definition to identify the section of the quantum circuit matching the first arrangement, preferably by identifying an arrangement of gates in the circuit that matches a circuit template specifying the first arrangement of gates.

14. A method according to claim 13, comprising repeating the processing, determining and modifying steps one or more times, until no further circuit sections matching the first arrangement are found.

15. A method according to claim 1, wherein the first arrangement comprises two gates implementing local interactions between respective adjacent pairs of qubits in a quantum system of at least three qubits and a third gate implementing the non-local interaction between a non-adjacent pair of the qubits.

16. A method according to claim 1, wherein the quantum circuit comprises at least three qubits, the first arrangement of gates comprising first and second SWAP gates arranged, respectively, before and after a further gate to implement an interaction between two non-adjacent ones of the three qubits, wherein the first arrangement of gates comprises a further gate prior to the first SWAP gate providing an input to the first SWAP gate and/or a further gate subsequent to the second SWAP gate utilising an output of the second SWAP gate.

17. A method according to claim 15, wherein the gates used in the first gate arrangement (other than SWAP gates) are of a common gate type T, wherein the common gate type T is one of: the A gate, and the evolution operator of the 1D Heisenberg model, and wherein the second arrangement comprises two gates of the gate type T operating on respective adjacent pairs of the qubits.

18. (canceled)

19. (canceled)

20. (canceled)

21. A method according to claim 1, wherein at least one of:
the first arrangement of quantum gates is a gate arrangement as shown in arrangement 220 of FIG. 2B or as shown in FIG. 3A; and
the second arrangement of quantum gates is a gate arrangement as shown in arrangement 222 of FIG. 2B or as shown in FIG. 3B.

22. (canceled)

23. A method according to claim 1, wherein the first and second arrangements of gates are defined by respective sides of the pentagon equation, preferably defined as
T₂₃T₁₂=T₁₂T₁₃T₂₃,
wherein the first, uncompressed, gate arrangement is defined by T₁₂T₁₃T₂₃ and the second, compressed, gate arrangement is defined by T₂₃T₁₂.

24. A method according to claim 1, comprising outputting the modified circuit definition to a quantum transpiler for transpilation to a target quantum computer, wherein the transpiler outputs the compressed, transpiled circuit to a quantum controller for implementation on a quantum processing unit, and executing the circuit defined by the modified circuit definition by the quantum controller using the quantum processing unit.

25. A system for compressing a quantum circuit, the system comprising a computer device having a processor with associated memory being configured to:
receive data defining a quantum circuit, the quantum circuit including at least one section that matches a predetermined first arrangement of quantum gates, the first arrangement including a non-local interaction and being associated with a predetermined second arrangement of quantum gates that does not include the non-local interaction;
determine whether the circuit section meets a compression criterion;
in response to determining that the circuit section meets the compression criterion, modify the circuit definition to replace the first arrangement of quantum gates with the second arrangement of quantum gates; and
output the modified circuit definition.

26. A system according to claim 25, further comprising a quantum computer coupled to the computer device.

27. A non-transitory computer readable medium comprising software code adapted, when executed by a data processing system, to perform operations comprising:
receiving data defining a quantum circuit, the quantum circuit including at least one section that matches a predetermined first arrangement of quantum gates, the first arrangement including a non-local interaction and being associated with a predetermined second arrangement of quantum gates that does not include the non-local interaction;
determining whether the circuit section meets a compression criterion;
in response to determining that the circuit section meets the compression criterion, modifying the circuit definition to replace the first arrangement of quantum gates with the second arrangement of quantum gates; and
outputting the modified circuit definition.
